(19) United States
(12) Patent Application Publication
(10) Pub. No.: US 2017/0073256 A1
(43) Pub. Date: Mar. 16, 2017

(54) System And Process To Protect Chlorine-Susceptible Water Treatment Membranes From Chlorine Damage Without The Use Of Chemical Scavengers

(71) Applicant: Cameron Solutions, Inc., Houston, TX (US)

(72) Inventor: Marcus D. Sprenkel, Houston, TX (US)

(21) Appl. No.: 14/852,087

(22) Filed: Sep. 11, 2015

(51) Int. Cl. C02F 1/70; C02F 1/44

(52) U.S. Cl. CPC C02F 1/70; C02F 1/441; C02F 1/442; C02F 1/444; C02F 2101/12

(57) ABSTRACT

A system and process to protect chlorine-susceptible water treatment membranes from chlorine damage without the use of chemical scavengers employs a catalytic deoxygenation system located upstream of the chlorine-susceptible membranes. The system and process not only achieves the required oxygen discharge levels, via reaction of the oxygen with hydrogen, but also dechlorinates the water, via reaction of the chlorine species with hydrogen.

### BACKGROUND

This invention relates to systems and processes that use nanofiltration or reverse osmosis membrane systems to treat a water stream. More particularly, the invention relates to systems and processes that treat a water stream, which could be a seawater stream, for reinjection in oilfield applications.

To prevent organic growth in water treatment systems, chlorine typically in the form of hypochlorite is dosed into the water being treated. While effective for preventing the organic growth, the chlorine can permanently damage membrane technologies such as nanofiltration and reverse osmosis membranes used in the treatment process, rendering the membranes inactive or ineffective.

In cases where the treatment process requires the water to be free from chlorine and oxygen, scavenging chemicals such as sodium bisulfite, along with the associated chemical injection equipment, are a required component of the process system design to allow for the necessary (reduced) levels of chlorine and oxygen to be achieved.

Deoxygenation of water using conventional technologies upstream or downstream of membrane systems has been used, but chemical scavenging is still required because the treated water still has residual oxygen or residual chlorine or both in it. The residual chorine can damage the membranes. The scavenging chemical is injected upstream of the membranes for chlorine removal and downstream of the membranes into the deoxygenation equipment, for removal of residual oxygen that cannot be removed by the deoxygenation equipment.

Therefore, a need exists for systems and processes that can dechlorinate a water feed ahead to the membrane technologies without the need for chemical scavengers and its associated dosing equipment (which is required by other oxygen removal technologies).

### SUMMARY OF THE INVENTION

A preferred embodiment of a system and process to protect chlorine-susceptible water treatment membranes from chlorine damage without the use of chemical scavengers employs a catalytic deoxygenation system upstream of the chlorine-susceptible membranes. The system and process not only achieves the required oxygen discharge levels, via reaction of the oxygen with hydrogen, but also dechlorinates the water, via reaction of the chlorine species with hydrogen.

A chlorine-dosed water feed, or a water feed having chlorine present, is mixed with hydrogen and passed through a catalyst bed-based deoxygenation unit. The deoxygenated and dechlorinated water product then passes through a filtration system having selectively permeable membrane technologies. The selectively permeable membranes provide a membrane permeate comprised of a portion of the feed from which contaminants, such as dissolved inorganic salts and organic constituents, have been removed. The filtration system may be a nanofiltration or reverse osmosis membrane system. The filtration system may have one or two stages, with each stage containing one or more membrane elements.

A process for protecting chlorine-susceptible permeable membranes includes the steps of

(i) mixing hydrogen with a water stream containing chlorine to produce a mixed water feed;

(ii) routing the mixed water stream to a catalyst bed-based deoxygenation unit;

(iii) removing a deoxygenated and dechlorinated water stream from the catalyst bed-based deoxygenation unit; and

(iv) routing the deoxygenated and dechlorinated water stream to a filtration system having a plurality of selectively permeable membranes (arranged in one or more stages), the catalyst bed-based deoxygenation unit being arranged upstream of the filtration system. No chemical scavenger dosing step occurs between the steps (iii) and (iv).

The objectives of this invention are to (1) protect the chorine-susceptible membrane technologies without the need for chemical scavengers and the associated dosing equipment; (2) prolong membrane life and effectiveness; (3) simplify the dechlorination process and reduce its footprint and operating cost; and (4) reduce or eliminate downtime due to in-place cleaning of the membranes.

### BRIEF DESCRIPTION OF THE DRAWINGS

FIG. 1 shows a preferred embodiment of the system and process for protect chlorine-susceptible water treatment membranes from chlorine damage without the use of chemical scavengers. The filtration system in FIG. 1 is a two-stage nanofiltration membrane system.

FIG. 2 shows another preferred embodiment of the system and process. The filtration system in FIG. 2 is a single stage reverse osmosis membrane system.

FIG. 3 shows yet another preferred embodiment of the system and process. A single stage microfiltration or ultrafiltration membrane system is placed upstream of the catalytic bed-based deoxygenation unit to filter the incoming water stream. The deoxygenation unit is then followed by a nanofiltration or reverse osmosis membrane system (or a parallel-arranged combination of the two).

### ELEMENTS AND ELEMENT NUMBERING USED IN THE DRAWINGS AND THE DETAILED DESCRIPTION

10 System (and process)
20 Two-stage nanofiltration membrane system
30 Catalyst bed-based deoxygenation unit
40 Chlorine-dosed water feed or stream or water feed containing chlorine
50 First stage nanofiltration membrane unit
60 First stage nanofiltration membrane unit
70 Membrane permeate
80 Membrane reject
90 Membrane permeate
95 Combined membrane permeate stream from first stage
98 Combined membrane permeate stream from first and second stages
100 Membrane reject
105 Combined membrane reject stream
110 Second stage nanofiltration membrane unit
120 Membrane permeate
130 Concentrated membrane reject
140 Hydrogen or hydrazine supply
150 Combined water and hydrogen (or hydrazine) stream
160 Deoxygenated and chlorine-reduced water product or feed
170 Single-stage reverse osmosis membrane system
180 Reverse osmosis membrane unit
190 Reverse osmosis membrane unit
200 Membrane permeate
210 Membrane reject
220 Membrane permeate
225 Combined membrane permeate stream
230 Membrane reject
240 Concentrated membrane reject
260 Microfiltration or ultrafiltration system
265 Filtered chlorine-dosed water feed or water feed containing chlorine
270 Mixing system (e.g. static mixer, mixing valve, or a combination thereof
275 Combined water feed and hydrogen stream
280 Stream of backwash water
285 Backwash water supply
290 Backwash discharge
295 Stream of compressed air
300 Air scour supply

### DETAILED DESCRIPTION OF THE PREFERRED EMBODIMENTS

A system and process made according to this invention deoxygenates and dechlorinates a water feed dosed with, or containing, chlorine prior to the feed reaching chlorine-susceptible membrane technologies. The water feed is mixed with hydrogen (or hydrazine) and enters a catalytic bed-based deoxygenation unit. The hydrogen reacts with the oxygen and chlorine species present in the feed to produce a deoxygenated and dechlorinated water product. This water product then enters a filtration system having a nanofiltration or a reverse osmosis membrane system (or parallel arranged nanofiltration and reverse osmosis membrane systems). No chemical scavenging is required between the deoxygenation unit and the membrane systems.

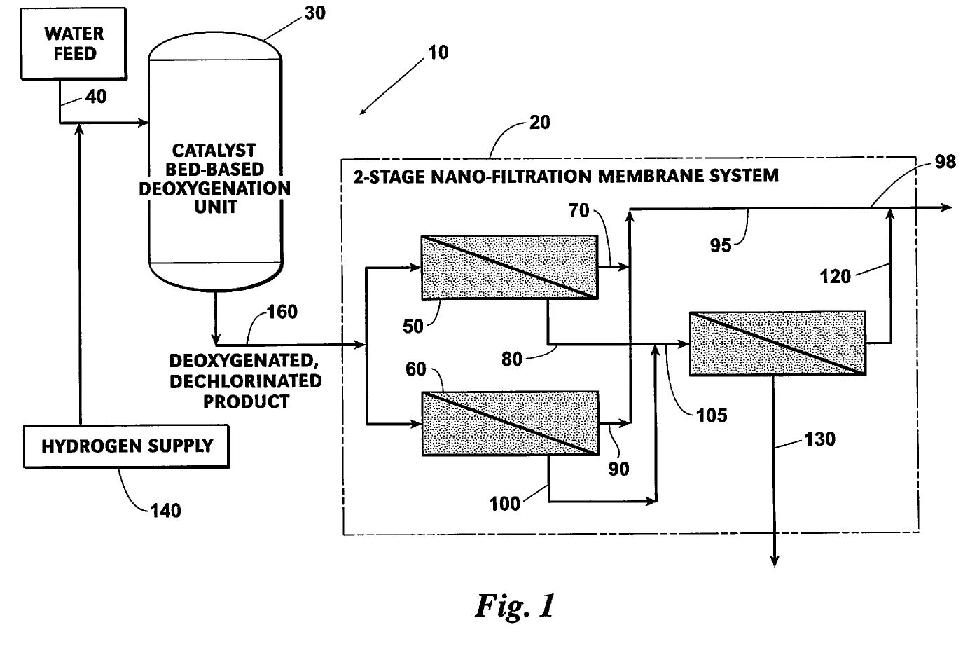

Referring first to FIG. 1, a preferred embodiment of a system 10 includes catalyst bed-based deoxygenation unit 30 arranged upstream of a two-stage nanofiltration membrane system 20. The number of membrane units in the each stage may vary with the quantity and quality of water to be processed, the amount of available space, and other factors.

A water feed 40 containing chlorine is mixed with hydrogen from a hydrogen or hydrazine supply 140 to form a combined water and hydrogen (or hydrazine) stream 150, which is fed to the catalyst bed-based deoxygenation unit 30. The catalyst bed-based deoxygenation unit 30 removes dissolved oxygen and chlorine from the water by reacting it with hydrogen, creating a deoxygenated and dechlorinated water product or feed 160. The feed 160 is then directed to one of two first-stage nanofiltration membrane units 50, 60.

Each first-stage nanofiltration membrane unit 50, 60 contains a plurality of selectively permeable membranes that contact the feed 160. A portion of the feed 160 passes through the membranes 50, 60, forming a membrane permeate 70, 90 that is substantially free of any dissolved inorganic salts and organic constituents. The streams of membrane permeate 70, 90 from the first-stage nanofiltration membrane units 50, 60 are mixed to form a combined membrane permeate stream 95.

The remaining portion of the feed 160, which contains the dissolved inorganic salts and organic constituents that are too large to pass through the membranes 50, 60, is concentrated into a stream of membrane reject 80, 100. The streams of membrane reject 80, 100 from the first-stage nanofiltration membrane units 50, 60 are mixed to form a combined membrane reject stream 105 and routed to the second-stage nanofiltration membrane unit 110. This nanofiltration membrane unit 110 also contains a plurality of selectively permeable membranes.

These membranes 110 contact the combined membrane reject stream 105 and allow a portion of it to pass through the membranes 110, forming a membrane permeate 120 that is substantially free of the dissolved inorganic salts and organic constituents. The remaining portions of combined membrane reject stream 105, which contains the dissolved inorganic salts and organic constituents that are too large to pass through the membranes 110, forms a stream of concentrated membrane reject 130 which may be sent to disposal.

The stream of membrane permeate 120 from the second-stage nanofiltration membrane unit 110 may be mixed with the combined membrane permeate stream 95 from the first-stage nanofiltration membrane units 50, 60 to form a combined membrane permeate stream from the first and second stages 98.

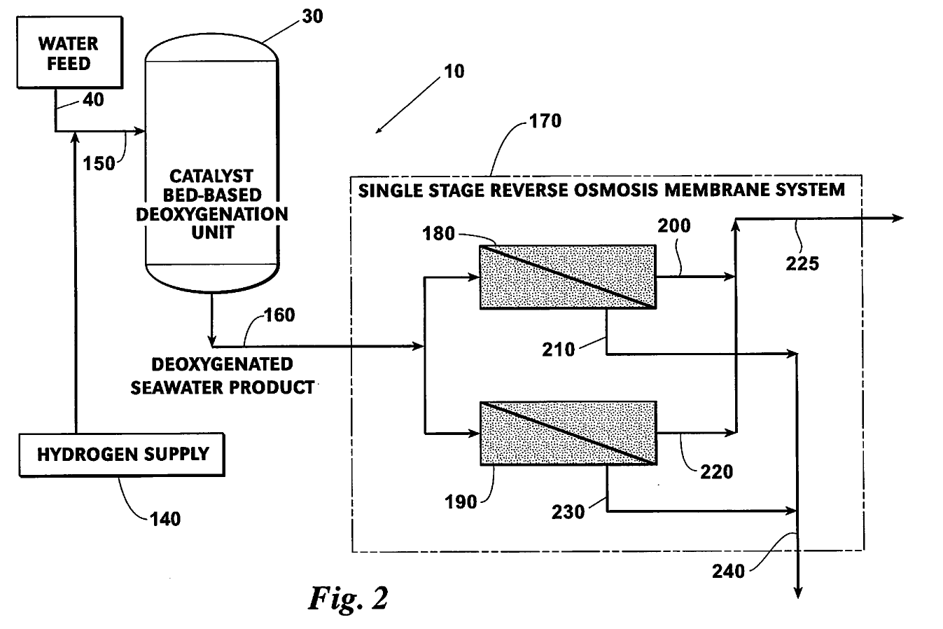

Referring now to FIG. 2, another preferred embodiment of system 10 includes a catalyst bed-based deoxygenation unit 30 arranged upstream of a single-stage reverse osmosis membrane system 170. Although two membrane units are shown in FIG. 2, the number of membrane units may vary with the quantity and quality of the raw seawater to be processed, the amount of available space, and other factors. Additionally, a reverse osmosis membrane system may be arranged in parallel with a nanofiltration membrane system, with one portion of the incoming feed passing thorough the nanofiltration membrane system while another portion passes through the reverse osmosis membrane system.

A water feed 40 containing chlorine is mixed with hydrogen from a hydrogen or hydrazine supply 140 to form a combined water and hydrogen (or hydrazine) stream 150, which is fed to the catalyst bed-based deoxygenation unit 30. The catalyst bed-based deoxygenation unit 30 removes dissolved oxygen and chlorine from the water by reacting it with hydrogen, creating a deoxygenated and dechlorinated water product or feed 160. The feed 160 is then directed to one of two reverse osmosis membrane units 180, 190.

Each reverse osmosis membrane unit 180, 190 contains a plurality of selectively permeable membranes that contact the product 160. A portion of the feed 160 passes through the membranes, forming a membrane permeate 200, 220 that is substantially free of dissolved inorganic salts and organic constituents. The streams of membrane permeate 200, 220 from the reverse osmosis membrane units 180, 190 are mixed to form a combined membrane permeate stream 225.

The remaining portion of feed 160, which contains dissolved inorganic salts and organic constituents that are too large to pass through the membranes 180, 190 is concentrated into a stream of membrane reject 210, 230. The streams of membrane reject 210, 230 from the reverse osmosis membrane units 180, 190 are combined to form a stream of concentrated membrane reject 240 which may be sent to disposal or be combined and routed to a filtration membrane unit or units at downstream next stage. This process may be repeated until the final stage, which routes the membrane reject for disposal.

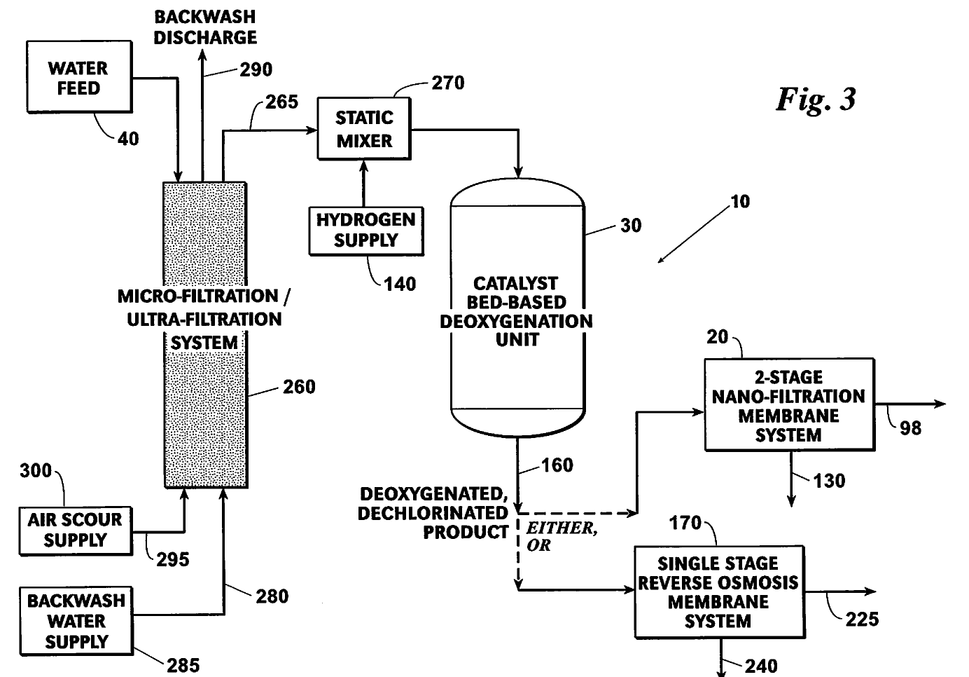

Referring to FIG. 3, another preferred embodiment of system 10 includes a microfiltration or an ultrafiltration system 260 arranged upstream of the catalyst bed-based deoxygenation unit 30. Microfiltration or “MF” may remove particulates that are equal to or greater than 0.1 micrometers in size, while ultrafiltration or “UF” may remove particulates that are equal to or greater than 0.01 micrometers in size. Although one filtration system 260 is shown in FIG. 3, the number of filtration systems may vary with the quantity and quality of the raw seawater to be processed, the amount of available space, and other factors.

A water feed 40 containing chlorine passes through the filtration system 260, forming a stream of membrane permeate 265 that is substantially free of inorganic salts and organic constituents but still containing chlorine. If a raw or untreated water feed is used, chlorine dosing and its associated dosing equipment may be arranged upstream of the filtration system 260 or between the filtration system 260 and the catalytic bed-based deoxygenation unit 30 to provide water feed 40.

The organic constituents may be removed from the microfiltration or ultrafiltration system 260 by backwashing. In backwashing, a stream of backwash water 280 from a backwash water supply 285 is passed quickly through the microfiltration or ultrafiltration system 260 in a direction opposite to the normal direction of flow. The organic constituents trapped in the filtration system 260 are thus removed from the filter media and entrained in the backwash water 280.

The backwash water 280 then exits the filtration system 260 through the backwash overboard discharge 290 and may be sent for further treatment or disposal. Air scouring, in which a stream of compressed air 295 from an air scour supply 300 is blown through the filtration system 260 in the same direction as the stream of backwash water 280, may be used before or intermittently with backwashing to aid in the removal of organic constituents.

The membrane permeate 265, which contains chlorine, is mixed with hydrogen from a hydrogen or hydrazine supply 140 to form a combined water and hydrogen (or hydrazine) stream 150, which is fed to the catalyst bed-based deoxygenation unit 30. The hydrogen or hydrazine can be dispersed through feed 40 using a mixing system 270 such as a static mixer, mixing valve, or some combination thereof (the same can be done in the embodiments of FIGS. 1 and 2). The catalyst bed-based deoxygenation unit 30 removes dissolved oxygen and chlorine from the water by reacting it with hydrogen, creating a deoxygenated and dechlorinated water product or feed 160. The feed 160 is then directed to a nanofiltration or reverse osmosis filtration system 20 or 170 (see e.g. FIGS. 2 and 3). The nanofiltration and reverse osmosis membrane units may also be arranged in parallel, with the feed 160 being split between the two.

In the embodiments of FIGS. 1-3, the water feed 40 entering the catalyst bed-based deoxygenation unit 30 may have a chlorine content of about 8,000 ppb and the deoxygenated and dechlorinated water product or feed 160 exiting the deoxygenation unit 30 has no more than 50 ppb chlorine and preferably 10 ppb chlorine or less, with no chemical scavengers being used to achieve these levels. While preferred embodiments of a system and process to deoxygenate and dechlorinate a water feed dosed with, or containing, chlorine prior to the feed reaching chlorine-susceptible membrane technologies have been described in detail, a person of ordinary skill in the art understands that certain changes can be made in the arrangement of process steps and type of components used in the process without departing from the scope of the attached claims.

What is claimed is:

1. A system for protecting chlorine-susceptible permeable membranes, the system comprising:
a catalyst bed-based deoxygenation unit arranged upstream of a filtration system having a plurality of selectively permeable membranes, the catalyst bed-based deoxygenation unit further arranged to receive a water stream containing chlorine, the filtration system arranged to receive a deoxygenated and dechlorinated water stream from the catalyst bed-based deoxygenation unit.

2. A system according to claim 1 wherein no chemical scavenger dosing devices are located between the catalyst bed-based deoxygenation unit and the filtration system.

3. A system according to claim 1 further comprising a hydrogen or hydrazine supply arranged to add hydrogen or hydrazine to the water feed before the water feed enters the catalyst bed-based deoxygenation unit.

4. A system according to claim 2 further comprising a mixing system arranged to disperse the hydrogen or hydrazine into the water feed.

5. A system according to claim 1 wherein the filtration system includes a reverse osmosis membrane unit.

6. A system according to claim 1 wherein the filtration system includes a nanofiltration membrane unit.

7. A system according to claim 5 further comprising the filtration system having a first and a second stage, the second stage being arranged to receive a reject stream from the first stage.

8. A system according to claim 1 further comprising a microfiltration membrane system arranged upstream of the catalyst bed-based deoxygenation unit.

9. A system according to claim 1 further comprising an ultrafiltration membrane system arranged upstream of the catalyst bed-based deoxygenation unit.

10. A process for protecting chlorine-susceptible permeable membranes, the process comprising the steps of:
(i) mixing hydrogen or hydrazine with a water stream containing chlorine to produce a mixed water feed;
(ii) routing the mixed water stream to a catalyst bed-based deoxygenation unit;
(iii) removing a deoxygenated and dechlorinated water stream from the catalyst bed-based deoxygenation unit;
(iv) routing the deoxygenated and dechlorinated water stream to a filtration system having a plurality of selectively permeable membranes, the catalyst bed-based deoxygenation unit being arranged upstream of the filtration system;

11. A process according to claim 10 wherein no chemical scavenger dosing step occurs between the steps (iii) and (iv).

12. A process according to claim 10 wherein the filtration system includes a reverse osmosis membrane unit.

13. A process according to claim 10 wherein the filtration system includes nanofiltration membrane unit.

14. A process according to claim 13 wherein the filtration system includes a first and a second stage, the second stage being arranged to receive a reject stream from the first stage.

15. A process according to claim 10 further comprising the step of filtering the water stream or the mixed water stream prior to the steps (i) and (ii) respectively, the filtering step being a microfiltration or an ultrafiltration filtering step.
